SEQUENCE LISTING (1 sequence)

SEQ ID NO: 1 - RNA, 1502 nt, Bacillus velezensis
  source 1..1502: mol_type = rRNA
gacgaacgctggcggcgtgcctaatacatgcaagtcgagcggacagatgggagcttgctccctgatgttagcggcggacgggtgagtaacacgtgggtaacctgcctgtaagactgggataactccgggaaaccggggctaataccggatggttgtttgaaccgcatggttcagacataaaaggtggcttcggctaccacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcaaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacctttatggagccagccgccgaaggtgggacagatgattggggtgaagtcgtaacaaggtagccgtatcggaagg

(19) United States
(12) Patent Application Publication
(10) Pub. No.: US 2026/0020561 A1
(43) Pub. Date: Jan. 22, 2026

(54) USE OF AMINO ACID PEPTIDE SOLUTION PRODUCED BY DECOMPOSITION OF FISH SCALE USING BACILLUS VELEZENSIS FOR HEALTHY AND ROBUST GROWTH OF SOLANACEAE SEEDLING AND GROWTH PROMOTION OF SOLANACEAE

(71) Applicant: CH BIOTECH R&D CO., LTD., NANTOU COUNTY (TW)

(72) Inventors: HUI-LIANG WANG, NANTOU COUNTY (TW); YA-FANG HONG, NANTOU COUNTY (TW); CHIAO-FANG HSU, NANTOU COUNTY (TW)

(21) Appl. No.: 18/776,903

(22) Filed: Jul. 18, 2024

(51) Int. Cl. A01N 37/46; A01C 1/00

(52) U.S. Cl. CPC A01N 37/46; A01C 1/00

(57) ABSTRACT

A use of an amino acid peptide solution produced by decomposition of fish scales using Bacillus velezensis for healthy and robust growth of Solanaceae seedlings and growth promotion of Solanaceae plants is provided. Bacillus velezensis is deposited in Leibniz Institute DSMZ-German Collection of Microorganisms and Cell Cultures GmbH with an accession number of DSM 34894. The Bacillus velezensis is used to decompose fish scales and produce an amino acid peptide solution containing peptides and amino acids. The amino acid peptide solution is sprayed on leaf surfaces of the Solanaceae seedlings to make the Solanaceae seedlings grow healthy and robust and promote growth of the Solanaceae plants effectively and specifically.

### BACKGROUND OF THE INVENTION

### Sequence Listing Incorporated by Reference

The Sequence Listing written in file “957-3535-SEQUENCE LISTING-JUL18-2024.xml” created on Jul. 15, 2024 with modification date Jul. 18, 2024, file size 3,507 bytes, is hereby incorporated by reference in its entirety for all purposes.

### FIELD OF THE INVENTION

The present invention relates to a use of an amino acid peptide solution, especially to a use of an amino acid peptide solution produced by the decomposition of fish scales using Bacillus velezensis for healthy and robust growth of Solanaceae seedlings and growth promotion of Solanaceae plants. Thus, above-ground biomass of the Solanaceae is increased.

### DESCRIPTION OF RELATED ART

Fish scales are removed before cooking and eating, and the fish scales removed are usually discarded as waste in the past. Recently, there are more and more research related to the fish scales in order to make the best use of the fish scales and reduce the waste.

The fish scales contain about 50% collagen, most of which is produced into collagen peptides by enzymatic hydrolysis, and the collagen peptides are broadly applied to skincare products and) health supplements. The fish scales are rarely used as fertilizers for promotion of germination or growth of crops.

As to other fertilizers related to collagen, refer to Chinese Pat. Pub. No. 109890781A which provides an amino acid fertilizer composition prepared by treating livestock farming by-products (such as cowhide, pigskin, or cow bones) with acid, alkali, or protease to give crude collagen peptides and then hydrolyzing the crude peptides with Bacillus species. Thereby a fertilizer composed of crude collagen peptides and amino acids is obtained. Although the fertilizer composition facilitates growth of lettuces, the use of livestock farming by-products may cause zoonoses such as Bovine spongiform encephalopathy (BSE). Compared with the fertilizer from the livestock by-products, fish-based fertilizers have a lower risk of contamination and zoonoses.

Most of fish-based fertilizers available on the market are produced by composite fish materials including fish skin, fish bone, fish paste, fish powder, and recovered protein from surimi wash water. During manufacturing process, mixed strains such as yeast, lactic acid bacteria, Bacillus amyloliquefaciens, and Lactobacillus acidophilus are used. Thus, the manufacturing process is more complicated. Symbiosis Agx (American brand) is a fertilizer derived from whole freshwater fish while Aminoterra® is derived from enzymatic hydrolysis of salmon. Compared with products obtained by simple hydrolysis of fish scales, composite fish materials may lead to inconsistent quality of fertilizer products and poor reproducibility of effect due to different sources and ratios of raw materials.

The Solanaceae family are widely used and including common food such as potatoes, eggplant, tomatoes, bell pepper, chili peppers, and goji berry (wolfberry) and common ornamental plants such as colorful pepper, Vegetable Mercury, and Angel's Trumpes.

As to the bell pepper, it can be planted in the field about 30-35 days after seed germination, once 6-7 true leaves have unfolded. The seedling stage is about 1.5 months. Generally, robust seedlings have strong resistance, vigorous growth, and earlier flower and fruit, thereby leading to high yields. Robust seedlings are the initial crucial step towards successful cultivation of plants. That means the robust seedling is a base of high yield of the bell pepper. A common way to make the pepper seedling grow healthy and robust is through the application of fertilizer. Although the bell pepper has fertilizer tolerance, excessive fertilization still damages roots. Thus, fertilization during the seedling stage is extremely important. Most of the fertilizer used during the seedling stage of bell peppers are chemical fertilizers. However, the use of chemical fertilizers diminishes soil microorganisms and prevents nutrients from decomposition, resulting in soil pollution and changing ratios of original components of the soil. Thereby, growth of the bell pepper is further affected.

Thus, there is room for improvement and there is a need to introduce a novel way to make Solanaceae seedlings grow healthy and robust for increasing the yield and/or quality of Solanaceae plants.

### SUMMARY OF THE INVENTION

Therefore, it is a primary objective of the present invention to provide a use of an amino acid peptide solution produced by decomposition of fish scales using Bacillus velezensis for promoting healthy and robust growth of Solanaceae seedlings and enhancing the growth of Solanaceae plants. Bacillus velezensis is used to decompose fish scales and produce the amino acid peptide solution containing peptides and amino acids. The application of this amino acid peptide solution to Solanaceae plants is intended to facilitate the healthy growth of seedlings and promote the growth of mature Solanaceae plants.

In order to achieve the above objectives, a use of an amino acid peptide solution derived from decomposition of fish scales using Bacillus velezensis to promote the healthy and robust growth of Solanaceae seedlings and facilitate the growth of Solanaceae plants is provided. The Bacillus velezensis is deposited in Leibniz Institute DSMZ-German Collection of Microorganisms and Cell Cultures GmbH with an accession number of DSM 34894. A bacterial solution containing Bacillus velezensis is used to decompose a fish scale material and produce a fish-scale amino acid peptide solution. Then, the solution containing peptides and amino acid, is sprayed on leaf surfaces of the Solanaceae seedlings to help the Solanaceae seedlings grow healthy and robust and promote their development.

In some embodiments, a concentration of the peptides and amino acids in the above fish-scale amino acid peptide solution is ranging from 50 ppm to 250 ppm.

In some embodiments, a concentration of the peptides and amino acids in the above fish-scale amino acid peptide solution is 100 ppm.

In some embodiments, the Solanaceae plants include tomatoes, eggplants, peppers, potatoes, tobaccos, bladder cherries, ginseng fruit (Solanum muricatum), gold silver nightshade, black nightshade, goji berries (wolfberries), and chili peppers.

The fish-scale amino acid peptide solution according to the present invention has the following advantages. By spraying the fish-scale amino acid peptide solution on leaf surfaces of the Solanaceae, it fosters the robust and healthy growth of Solanaceae seedlings, while promoting the growth of the above-ground parts of the Solanaceae plants. These all help improve yields and filed management of the Solanaceae plants.

### BRIEF DESCRIPTION OF THE DRAWINGS

The structure and the technical means adopted by the present invention to achieve the above and other objectives can be comprehensively understood by referring to the following detailed description of the preferred embodiments and the accompanying drawings, wherein:

FIG. 1 are photos showing observation of a colony of strain CHB200 and observation of the strain CHB200 with a microscope according to the present invention;

FIG. 2 is a figure showing analysis of contents of amino acids and peptides in decomposition products of fish scales by strain CHB200 according to the present invention;

FIG. 3 are photos showing products obtained at different stages of large-scale fermentation of fish scales by strain CHB200 according to the present invention;

FIG. 4 are photos showing growth of bell pepper seedlings in control and treatment groups on day 28 after the bell pepper seedlings respectively sprayed with water (the control group) and 100 ppm fish-scale amino acid peptide solution twice on leaf surfaces and grown with sufficient light and water supply according to the present invention;

FIG. 5 are bar charts showing the number of leaves (A) and average chlorophyll content (B) of bell pepper seedlings respectively sprayed with water (the control group) and 100 ppm fish-scale amino acid peptide solution twice on leaf surfaces; the number of test samples is 10 (n=10) (*p<0.05; **p<0.01; ***p<0.001) according to the present invention;

FIG. 6 are bar charts showing plant height (A), leaf length (B), and leaf width (C) of bell pepper seedlings respectively sprayed with water (the control group) and 100 ppm fish-scale amino acid peptide solution twice on leaf surfaces; the number of test samples is 10 (n=10) (*p<0.05; **p<0.01; ***p<0.001) according to the present invention;

FIG. 7 are bar charts showing fresh weight (A) and dry weight (B) of bell pepper seedlings and the number of test samples is 10 (n=10) (*p<0.05; **p<0.01; ***p<0.001) according to the present invention.

### DETAILED DESCRIPTION OF THE PREFERRED EMBODIMENT

Robust and healthy bell pepper seedlings feature on stout stems, short internodes, and dark green leaf color. Once the bell pepper seedlings are healthy and robust, they have strong resistance, fast root growing after transplanting, vigorous growth, and early flowering and fruiting. Thus, yield is increased.

A use of an amino acid peptide solution produced by decomposition of fish scales using Bacillus velezensis to promote growth and keep healthy and robust growth of seedlings of the Solanaceae is provided. A bacterial solution containing the Bacillus velezensis is mixed with a fish scale material to form a mixed solution. After the fish scale material being decomposed by fermentation of the Bacillus velezensis in the bacterial solution, a fish-scale amino acid peptide solution containing peptides and amino acids is obtained. The fish-scale amino acid peptide solution is sprayed on leaf surfaces of seedlings of the Solanaceae to help the Solanaceae seedlings grow healthy and robust and promote growth of the Solanaceae seedlings effectively and specifically. It is also an increase in above-ground biomass. The Bacillus velezensis is deposited in Leibniz Institute DSMZ-German Collection of Microorganisms and Cell Cultures GmbH with an accession number of DSM 34894.

16S rRNA of the present Bacillus velezensis strain has 98% similarity with 16S rRNA of type strain (standard strain) of Bacillus velezensis B268 with an accession number of CP053764.1. This standard strain is not disclosed to have fish scale decomposing ability.

The mixed solution is fermented at 30-45° C. for 12-24 hours. The mixed solution includes contains 7-10% (w/v) of the bacterial solution of Bacillus velezensis, 15-40% (w/v) of the fish scale material, 0.12% (w/v) of buffer salts, and the rest percentage of pure water.

After steam sterilization, removal of debris by centrifugation, filtration, and concentrated, a clear and concentrated fish-scale amino acid peptide solution is obtained. The total concentration of peptides and amino acids in the fish-scale amino acid peptide solution is determined using the o-Phthaldialdehyde (OPA) test reagent, yielding a concentration of 30,000 ppm.

In a preferred embodiment, the fish scale material includes fish scales, sodium chloride (NaCl), dipotassium phosphate (K₂HPO₄), and monopotassium phosphate (KH₂PO₄).

In a preferred embodiment, the fish scale material includes fish scales, 0.5 g/L of sodium chloride (NaCl), 0.3 g/L of dipotassium phosphate (K₂HPO₄), and 0.4 g/L of monopotassium phosphate (KH₂PO₄).

The strain CHB200 of Bacillus velezensis is obtained from waste chicken feathers. As to techniques for separating and screening strain CHB200 of Bacillus velezensis, please refer to U.S. patent application Ser. Nos. 18/760,688 and 18/772,775 filed on Jul. 1, 2024, and Jul. 15, 2024, respectively.

Moreover, as to test content of fish scale fermentation ability of the strain CHB200, please refer to U.S. patent application Ser. Nos. 18/760,688 and 18/772,775 filed on Jul. 1, 2024, and Jul. 15, 2024, respectively.

In order to learn functions and features of the present invention more completely and clearly, please refer to the following detailed descriptions and related figures. Yet the following embodiments are not intended to limit the scope of the present invention.

<Isolation and Screening of Bacillus velezensis Strain CHB200>

Collect waste chicken feather. After washing, place 5 g of feathers into a conical flask and add 50 mL of sterile water to get a culture medium. Place the culture medium in a 37° C. incubator and culture overnight with a shaking speed at 200 rpm. Then, remove the feathers from the culture medium and centrifuge the culture medium. Remove supernatant and retain precipitate after centrifugation. Next dissolve the precipitate with 100 μL of sterile water and take and spread 20 μL of dissolved solution evenly on Lysogeny broth (LB) solid medium. Incubate the LB solid medium in the 37° C. incubator for 24 hours.

Pick a single colony grown on the LB solid medium, inoculate the colony in 3 ml of LB broth, and culture at 37° C. with a shaking speed at 200 rpm for 24 hours to get a bacteria solution.

Measure absorbance of the bacterial solution at a wavelength of 600 nm (known as OD (optical density) 600). Inoculate the bacterial solution with OD₆₀₀ of 10 therein into 100 mL of M3 fermentation medium containing 33% fish scale powder and ferment at 37° C. for 48 hours. Then perform hydrolysis test of fish scales. A concentration of the above bacterial solution with OD₆₀₀ of 10 is about 1×10⁹ CFU/mL and a composition of the M3 fermentation medium is shown in Table 1. Lastly, measure total concentration of amino acids in fermented solution to screen out a strain with fish scale decomposition ability.

TABLE 1

| | | concentration |
|---|---|---|
| | composition | (g/L) |
| substrate | fish scale | 330 |
| salts and buffer | NaCl | 0.5 |
| | K₂HPO₄ | 0.3 |
| | KH₂PO₄ | 0.4 |

A method of testing total concentration of amino acids is described briefly below.

Dissolve leucine in double-distilled water and prepare amino acid standard solutions with concentrations of 100-2000 ppm by serial dilution. Take 3 μL of amino acid standard solution or test sample (fermented solution), add 87 μL of ninhydrin reagent containing 0.6% ninhydrin, and mix evenly to get an intermediate mixture.

The intermediate mixture is reacted at 100° C. for 10 minutes. After cooling down to room temperature naturally, add 150 μL of 95% alcohol, and mix evenly to get a final mixed solution. Measure the absorbance of the final mixed solution at the wavelength of 570 nm (OD₅₇₀). Lastly, make a standard curve by absorbance of a set of the amino acid standard solutions obtained. Then, total concentration of amino acids in the test sample is calculated based on the standard curve.

Among the strains tested, a strain capable of decomposing fish scales is obtained and named as strain CHB200.

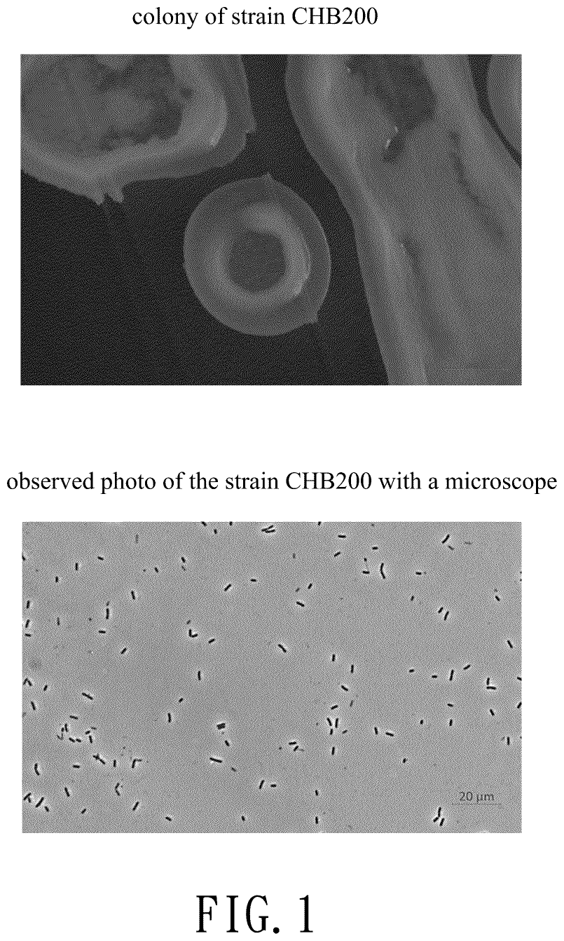

Referring to FIG. 1, a colony of the strain CHB200 is irregular round and transparent to white colored. While being observed under a microscope, the strain CHB200 is a rod with two blunt round ends. Compare 16S rRNA sequence of the strain CHB200 with sequence in Genbank database and the result shows that the strain CHB200 and the Bacillus velezensis B268 have 98% similarity in 16S rRNA sequence. 16S rRNA of the strain CHB200 is disclosed in SEQ ID NO: 1 of sequence listing.

### <Test of Fish Scale Fermentation Ability of the Strain CHB200>

Inoculate the strain CHB200 into 3 ml of LB broth and culture at 37° C. with shaking at 200 rpm for 24 hours to get a bacterial solution. Then, take and inoculate the bacterial solution with OD 600 of 10 therein onto 100 mL of M3 fermentation medium containing 33% fish scale powder and ferment at 37° C. to get a fermentation broth. Measure total concentration of peptides and amino acids in the fermentation broth before fermentation (0 hour) and after fermentation for 16 hrs, 24 hrs, 40 hrs, and 48 hrs. The concentration of peptides and amino acids minus the concentration of amino acids leaves the concentration of peptides.

A method of measuring total concentration of amino acids used in the test is the same as the above method using ninhydrin reagent. A method of measuring total concentration of peptides and amino acids used is using o-Phthaldialdehyde (OPA) and described briefly below.

First, prepare Leucine standard solutions. Take and add 10 μL of Leucine standard solutions and test samples respectively into wells of a 96-well plate. Then, add 100 μL of OPA solution into the standard solutions and the samples and immediately measure absorbance of the standard solutions and the samples at the wavelength of 340 nm (OD₃₄₀). Next make a standard curve by absorbance of the standard solutions obtained and calculate concentration of total concentration of peptides and amino acids in the respective samples tested according to the standard curve. The result obtained by the OPA method minus the total concentration of amino acids obtained by the ninhydrin reagent method leaves total concentration of peptides in the sample tested.

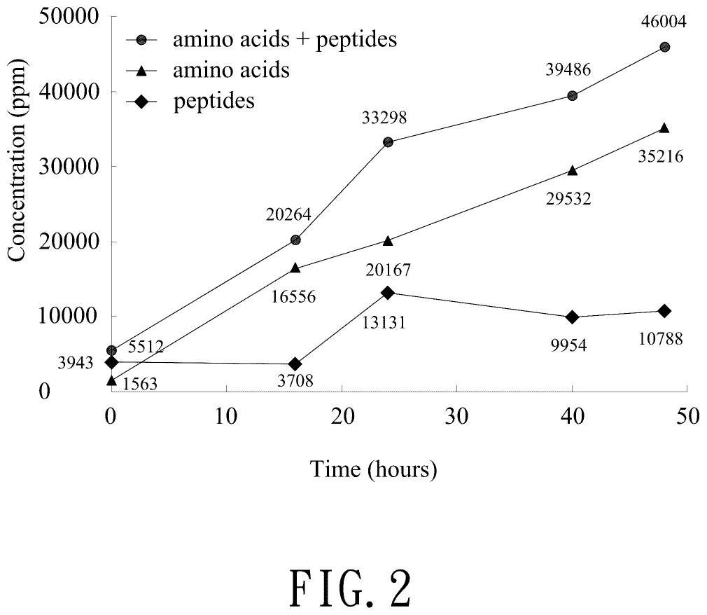

Refer to FIG. 2 and Table 2, the total concentration of amino acids and peptides in the fermentation broth is indeed increased significantly along with the increased fermentation time.

TABLE 2

| | 0 hr | 16 hrs | 24 hrs | 40 hrs | 48 hrs |
|---|---|---|---|---|---|
| total | 5512 | 20264 | 33298 | 39486 | 46004 |
| concentration | | | | | |
| of amino acids | | | | | |
| and peptides | | | | | |
| (ppm) | | | | | |
| total | 1569 | 16556 | 20167 | 29532 | 35216 |
| concentration | | | | | |
| of amino acids | | | | | |
| (ppm) | | | | | |
| total | 3943 | 3708 | 13131 | 9954 | 10788 |
| concentration | | | | | |
| of peptides | | | | | |
| (ppm) | | | | | |

### <Large-Scale Fermentation of Fish Scales by the Strain CHB200>

First, activate the strain CHB200 to get a bacterial solution. Inoculate the bacterial solution in LB broth, adjust final volume to 100 mL, and incubate at 37° C. with shaking for about 16 hours to get a saturated bacterial solution. Pour the saturated bacterial solution into a 10 L fermenter and continuously incubate at 37° C. with shaking for about 2-4 hours until OD₆₀₀ of the bacterial solution reaches 4.0. Then, pour the bacterial solution with OD₆₀₀ 4.0 into a 100-1000 L fermenter and incubate at 37° C. with shaking for about 2-4 hours until OD₆₀₀ reaches 4.0 to obtain a fermented bacterial solution.

Washed and cleaned fish scale materials are placed into a 100 L-10 T fermenter, and then add buffer salts and pure water to get a M3 fermentation broth containing fish scale material. The M3 fermentation broth is then sterilized at 121° C. and 1.5 atm for 30 minutes. The sterilized M3 fermentation broth is cooled down to 30-45° C., and added with the above fermented bacterial solution to get a fermentation broth. The fermentation broth is fermented at 37° C., and stirred continuously for introduction of air. The fermentation time is 12-24 hours to obtain a primary product of fermentation. A composition of the above fermentation broth contains 7-10% (w/v) fermented bacterial solution, 15-40% (w/v) fish scale material, 0.12% (w/v) buffer salts, and the rest percentage of pure water. The preferred ratio of the fish scale material in the fermentation broth is 20-35% (w/v) and the preferred fermentation time is 16-20 hours. The composition of the M3 fermentation broth is shown in Table 1.

The primary product of fermentation is centrifuged at 3000-5000 rpm or 9000-11000 rpm by a decanter centrifuge or tubular centrifuge. Keep supernatant to obtain a debris-free fermentation broth.

Then, the debris-free fermentation broth is centrifuged at 9000-12000 rpm or 9000-11000 rpm by a disc centrifuge or a tubular centrifuge. Remove bacteria sedimentation to get a clear fermentation broth and measure the total concentration of amino acids, total concentration of peptides, and nitrogen content of the clear fermentation broth.

Next, the clear fermentation broth is concentrated at 45-55° C. by a vacuum low temperature evaporator for 3-6 hours to get a concentrated fermentation broth. And measure the total concentration of amino acids, total concentration of peptides, and nitrogen content of the concentrated fermentation broth.

Methods of measuring the total concentration of amino acids and peptides are as shown in the above paragraphs related to the isolation and screening of Bacillus velezensis strain CHB200 and the test of fish scale fermentation ability of the strain CHB200 mentioned above, while a method of measuring nitrogen content is described briefly below.

Mount a homogeneous test sample into a tin foil capsule and add silicon dioxide (SiO₂) as an adsorbent. The capsule is sealed into a cylinder or a cube. Then use an elemental analyzer (Flash 2000, Thermo Fisher Scientific) to measure nitrogen and carbon contents in the test sample. Moreover, protein content in the test sample can be estimated by multiplying the nitrogen content by a factor of 6.25 since the average nitrogen content of proteins is found to be about 16 percent.

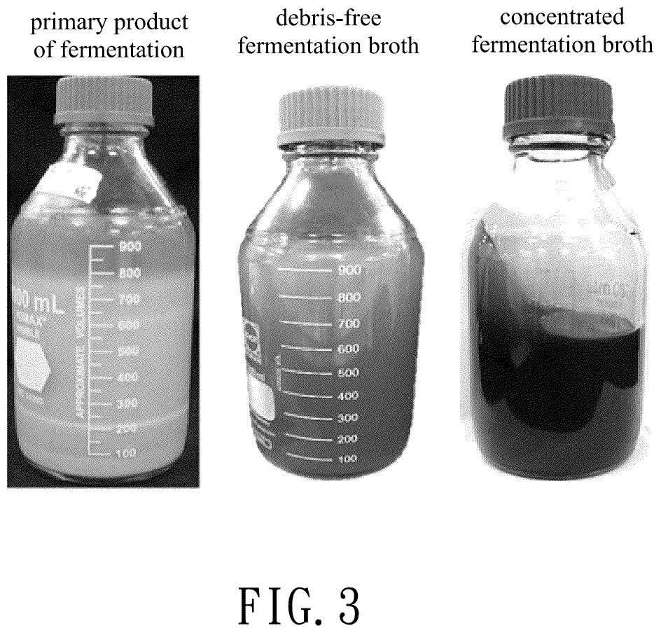

A composition analysis of the clear fermentation broth is performed by SGS Certification Taiwan. Total concentration of peptides and total concentration of amino acids in the clear fermentation broth are respectively 28164 ppm and 73080 ppm while nitrogen content and protein content in the clear fermentation broth are respectively 1.7% and 10.56%. In the concentrated fermentation broth, the total concentration of peptides and total concentration of amino acids are respectively 120510 ppm and 365015 ppm while nitrogen content, and protein content are respectively 6.9% and 43.125%. Refer to FIG. 3, photos of the primary product of fermentation (with debris), the debris-free fermentation broth, and the concentrated fermentation broth are provided.

According to the above test results, it is learned that the strain CHB200 of the Bacillus velezensis capable of decomposing fish scales is having good fish scale decomposing ability, and able to be applied to large-scale fermentation due to the effective decomposition of fish scales within a short period of time. Thus, the strain CHB200 has potential for industrial applications. Moreover, the fermentation broth obtained is rich in amino acids and peptides and thus able to be applied to agricultural fertilizer for growth promotion and healthy and robust growth of seedlings of the Solanaceae plants. The Solanaceae plants can be tomatoes, eggplants, peppers, potatoes, tobaccos, bladder cherries, Ginseng fruit (Solanum muricatum), gold silver nightshade, black nightshade, goji berries (wolfberries), or chili peppers.

A fermentation broth obtained by decomposition of fish scale material using the strain CHB200 is further used for preparation of a fish-scale amino acid peptide solution which is applied to Solanaceae seedlings. The followings are tests for showing healthy and robust growth and growth promotion of the Solanaceae seedlings by the fish-scale amino acid peptide solution. The concentration of the peptides and the amino acids in the fish-scale amino acid peptide solution is 50-250 ppm while 100 ppm is preferred. In the following tests, bell peppers of the Solanaceae family are test subjects and the concentration of the peptides and the amino acids in the fish-scale amino acid peptide solution being sprayed on leaf surfaces of the bell pepper is 100 ppm.

### <Experiment Material and Method>

The fermentation broth obtained by decomposition of fish scales using Bacillus velezensis is diluted with water to get a fish-scale amino acid peptide solution in which a total concentration of amino acids and peptides is 100 ppm.

Bell pepper seeds used are seeds of red bell pepper (Red Star, HV-259) from Known-You Seed Co., Ltd. The plating medium used is peat soil (GRAMOFLOR) and vermiculite (South Sea Vermiculite No. 2, fine diameter) in a ratio of 3:1. The daytime/nighttime temperature of a growth environment is set as 26/24° C. with 16 hours of daylight and 8 hours of darkness.

The fish-scale fermentation broth and water are applied in the following manner. 7 days after sowing, screen out seedlings with uniform growth. The leaf surfaces of the bell pepper seedlings are respectively applied with water (control group) and 100 ppm fish-scale amino acid peptide solution (peptides and amino acids) (treatment group) at days 14 and 21 after sowing. The liquid (water or fish-scale amino acid peptide solution) applied at days 14 and 21 are respectively 0.5 ml and 1 ml per seedling. At day 28 after sowing, analyze physiological data such as the number of leaves, plant height, leaf length, leaf width, leaf chlorophyll content measured by SPAD 502 Plus (Spectrum technologies Inc.), fresh weight, and dry weight of the bell pepper seedlings of both the control group and the treatment group. The data is analyzed by excel Student's t-test function (*p<0.05; **p<0.01; ***p<0.001).

### Experiment Results

With sufficient light and water, observe and take photos of the bell pepper seedlings to record the growth. The bell pepper seedlings respectively sprayed with water (control group) and 100 ppm fish-scale amino acid peptide solution (treatment group) every day.

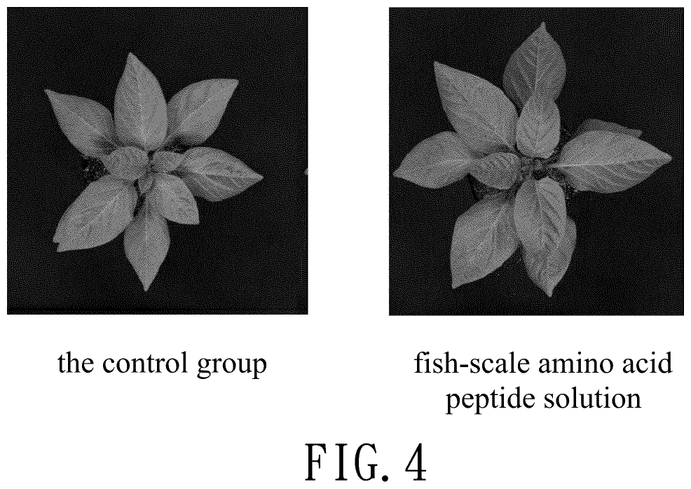

FIG. 4 is a photo (with 10 test samples) showing the growth of the bell pepper seedlings in the control group and the treatment group at day 28. Referring to the photo shown in FIG. 4, it is learned that under conditions with sufficient light and water, the bell pepper seedling sprayed with the fish-scale amino acid peptide solution on leaf surfaces twice obviously grows stronger and higher compared with the bell pepper seedling sprayed with water on leaf surfaces twice.

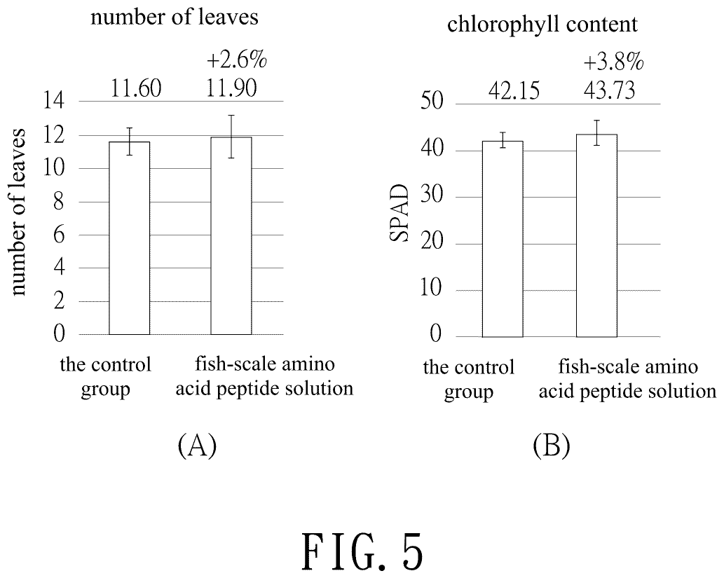

Compared to the bell pepper seedling sprayed with water on the leaf surfaces twice, the bell pepper seedling sprayed with the fish-scale amino acid peptide solution twice shows a respectively increased 2.6% in the number of leaves (refer to FIG. 5A) and 3.8% in chlorophyll content (refer to FIG. 5B). The number of the test samples is 10 (n=10) (*p<0.05; **p<0.01; ***p<0.001).

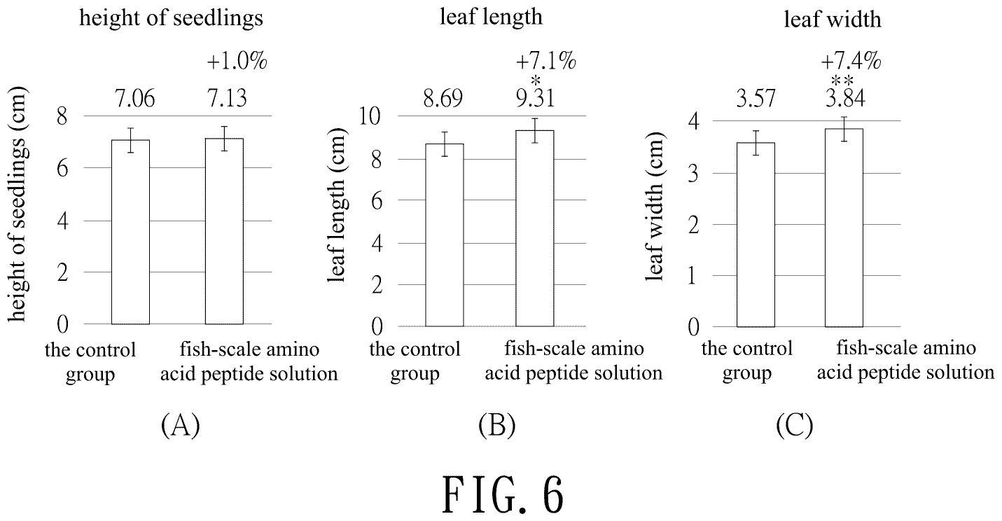

Moreover, compared to the bell pepper seedling sprayed with water on the leaf surfaces twice, the bell pepper seedling sprayed with the fish-scale amino acid peptide solution twice shows increases of 1.0% in the plant height (refer to FIG. 6A), 7.1% in the leaf length (refer to FIG. 6B), and 7.4% in the leaf width (refer to FIG. 6C), respectively. The number of the test samples is 10 (n=10) (*p<0.05; **p<0.01; ***p<0.001).

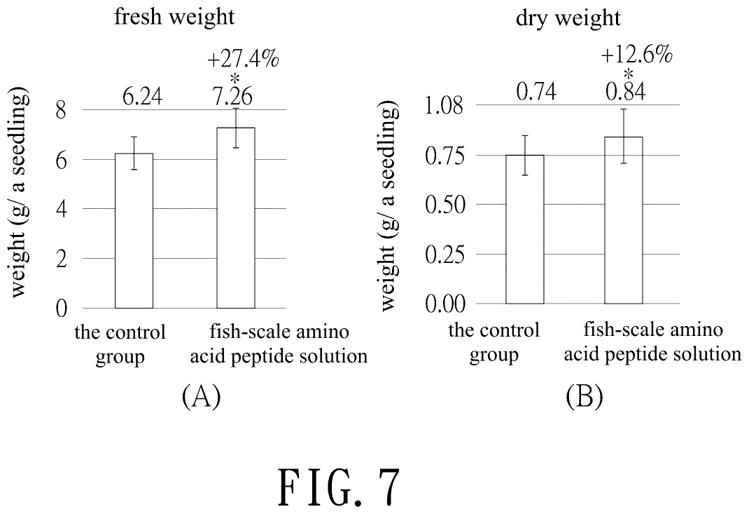

Compared to the bell pepper seedling sprayed with water on the leaf surfaces twice, the bell pepper seedling sprayed with the fish-scale amino acid peptide solution twice shows an increase 27.4% in fresh weight (refer to FIG. 7A) and 12.6% in dry weight (refer to FIG. 7B), respectively. The number of the test samples is 10 (n=10) (*p<0.05; **p<0.01; ***p<0.001).

According to the above results, it is learned that the fish-scale amino acid peptide solution, derived from the decomposition of fish scales using Bacillus velezensis and applied to leaf surfaces of bell pepper seedlings according to the present invention, indeed keeps the bell pepper seedlings growing healthy and robust and also facilitates growth of the bell pepper seedlings. Compared to the control group, the plant height, the leaf length, the leaf width, the fresh weight, and the dry weight of the bell pepper seedlings of the treatment group are respectively increased 1.0%, 7.1%, 7.4%, 27.4%, and 12.6%. The application of amino acid peptide solution, obtained by decomposition of fish scales using Bacillus velezensis, to the leaf surfaces of the bell pepper seedlings can promote growth of the above-ground part of the bell pepper. This application results in healthier bell pepper seedlings characterized by robust growth, stout stems, and a deep green leaf color.

Throughout the tests, it is observed that the Solanaceae seedlings treated with the amino acid peptide solutions of varying concentration all show no signs of phytotoxicity.

Therefore, the fish-scale amino acid peptide solution, derived from the decomposition of fish scales using Bacillus velezensis and applied to the leaf surface of the Solanaceae, not only fosters robust and healthy growth in Solanaceae seedlings and promotes overall seedling development, but also contributes to enhancing field management practices and ultimately increasing the yield of Solanaceae crops.

Additional advantages and modifications will readily occur to those skilled in the art. Therefore, the invention, in its broader aspects, is not limited to the specific details and representative devices shown and described herein. Accordingly, various modifications may be made without departing from the spirit or scope of the general inventive concept as defined by the appended claims and their equivalent.

What is claimed is:

1. A use of an amino acid peptide solution produced by decomposition of fish scales using Bacillus velezensis for healthy and robust growth of Solanaceae seedlings is provided; the Bacillus velezensis is deposited in Leibniz Institute DSMZ-German Collection of Microorganisms and Cell Cultures GmbH with an accession number of DSM 34894; a fish scale material is decomposed by a bacterial solution containing the Bacillus velezensis to produce the fish-scale amino acid peptide solution; the fish-scale amino acid peptide solution is containing peptides and amino acids and able to promote healthy and robust growth of the Solanaceae seedlings effectively and specifically.

2. The use as claimed in claim 1, wherein a concentration of the peptides and the amino acids in the fish-scale amino acid peptide solution is ranging from 50 ppm to 250 ppm.

3. The use as claimed in claim 2, wherein the concentration of the peptides and the amino acids in the fish-scale amino acid peptide solution is 100 ppm.

4. The use as claimed in claim 3, wherein the Solanaceae includes tomatoes, eggplants, peppers, potatoes, tobaccos, bladder cherries, Ginseng fruit (Solanum muricatum), gold silver nightshade, black nightshade, goji berries (wolfberries), and chili peppers.

5. The use as claimed in claim 4, wherein the Solanaceae is bell pepper.

6. The use as claimed in claim 2, wherein the Solanaceae includes tomatoes, eggplants, peppers, potatoes, tobaccos, bladder cherries, Ginseng fruit (Solanum muricatum), gold silver nightshade, black nightshade, goji berries (wolfberries), and chili peppers.

7. The use as claimed in claim 6, wherein the Solanaceae is bell pepper.

8. The use as claimed in claim 1, wherein the Solanaceae includes tomatoes, eggplants, peppers, potatoes, tobaccos, bladder cherries, Ginseng fruit (Solanum muricatum), gold silver nightshade, black nightshade, goji berries (wolfberries), and chili peppers.

9. The use as claimed in claim 8, wherein the Solanaceae is bell pepper.

10. A use of an amino acid peptide solution produced by decomposition of fish scales using Bacillus velezensis for growth promotion of Solanaceae plants is provided; the Bacillus velezensis is deposited in Leibniz Institute DSMZ-German Collection of Microorganisms and Cell Cultures GmbH with an accession number of DSM 34894; a fish scale material is decomposed by a bacteria solution containing the Bacillus velezensis to produce the fish-scale amino acid peptide solution; the fish-scale amino acid peptide solution is containing peptides and amino acids and able to promote growth of the Solanaceae plants effectively and specifically.

11. The use as claimed in claim 10, wherein a concentration of the peptides and the amino acids in the fish-scale amino acid peptide solution is ranging from 50 ppm to 250 ppm.

12. The use as claimed in claim 11, wherein the concentration of the peptides and the amino acids in the fish-scale amino acid peptide solution is 100 ppm.

13. The use as claimed in claim 12, wherein the Solanaceae plants include tomatoes, eggplants, peppers, potatoes, tobaccos, bladder cherries, Ginseng fruit (Solanum muricatum), gold silver nightshade, black nightshade, goji berries (wolfberries), and chili peppers.

14. The use as claimed in claim 13, wherein the Solanaceae plant is bell pepper.

15. The use as claimed in claim 11, wherein the Solanaceae plants include tomatoes, eggplants, peppers, potatoes, tobaccos, bladder cherries, Ginseng fruit (Solanum muricatum), gold silver nightshade, black nightshade, goji berries (wolfberries), and chili peppers.

16. The use as claimed in claim 15, wherein the Solanaceae plant is bell pepper.

17. The use as claimed in claim 10, wherein the Solanaceae plants include tomatoes, eggplants, peppers, potatoes, tobaccos, bladder cherries, Ginseng fruit (Solanum muricatum), gold silver nightshade, black nightshade, goji berries (wolfberries), and chili peppers.

18. The use as claimed in claim 17, wherein the Solanaceae plant is bell pepper.
